(19) United States
(12) Patent Application Publication
(10) Pub. No.: US 2010/0206682 A1
(43) Pub. Date: Aug. 19, 2010

(54) FRICTION CLUTCH DISCONNECT FOR WATER PUMP

(75) Inventors: Philip GEORGE, WOOSTER, OH (US); Mavinkal JAYARAM, BROADVIEW, OH (US)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 12/706,821

(22) Filed: Feb. 17, 2010

Related U.S. Application Data
(60) Provisional application No. 61/153,768, filed on Feb. 19, 2009.

(51) Int. Cl. F16D 13/14

(52) U.S. Cl. 192/76

(57) ABSTRACT

The invention uses a frictional clutch to disengage the vehicle water pump. Actuating methods for the clutch include electromagnetic, vacuum piston and an external solenoid. The clutch is engaged with a diaphragm spring.

### FIELD OF THE INVENTION

This invention relates to internal combustion engines which are especially suited for vehicles and more particularly to water pumps which have a clutch to allow them to be disengaged so that the impeller does not circulate cooling fluids during times of start up and cold weather.

### BACKGROUND OF THE INVENTION

Conventional water pumps for internal combustion engines are driven by a belt which interacts with a pulley of a water pump. The pulley is permanently fixed to the shaft of the pump so as to constantly run the impeller of the pump, thereby constantly circulating water. In order to decrease the time for warm up of the engine, it has been suggested to include a clutch in the pump so as to disengage the pulley from the shaft.

### OBJECTS OF THE INVENTION

The object of the invention is to provide a simple clutch mechanism for use in a water pump of an internal combustion engine that allows the pulley to be disconnected from the shaft for short periods of time.

These and other objects of the invention become more readily understood by reference to the following description of the invention.

### SUMMARY OF THE INVENTION

The objects of the invention are achieved by using a clutch having frictional surfaces which are radially oriented and an actuator which, when engaged, disengages the frictional surfaces, thereby disengaging the pulley from the shaft.

Broadly, the invention can be defined as a water pump with a clutch for an internal combustion engine, comprising: a pump housing having a pump shaft therein; a pulley rotatably mounted on the pump housing, the pulley having a radial clutch engagement surface; a clutch having a spring, a drive plate, and a movable pressure plate, the drive plate is radially mounted about the pump shaft and positioned axially between the clutch engagement surface and the pressure plate, the pressure plate is radially mounted about the pump shaft and is axially adjacent the drive plate, and the spring radially mounted about the pump shaft and urges the pressure plate, the drive plate, and the clutch engagement surface into frictional engagement with each other; and an actuator for moving the pressure plate out of engagement with the drive plate and disconnecting the pulley from the pump shaft.

The actuator of the invention can be described as one of three of the following preferred embodiments.

One embodiment of the actuator is an electromagnetic actuator having a coil and a movable plunger. The plunger is engagable with the pressure plate when the coil is energized so as to move the pressure plate out of engagement with the drive plate.

Another embodiment of the actuator is a solenoid mounted externally to the pump housing. A movable ramped plate is radially mounted about the pump shaft in the housing. The ramped plate is axially spaced apart from and engagable with the pressure plate. A base plate is radially mounted about the pump shaft in the housing and is spaced axially adjacent to the ramped plate. Roller elements are fixed to the base plate and in rolling engagement with the ramped plate. The solenoid has a solenoid shaft that engages and rotates the ramped plate when the solenoid is energized so that the roller elements axially move the ramped plate to engage and move the pressure plate out of engagement with the drive plate.

A third embodiment of the actuator is a vacuum piston mounted in the housing with a piston member connected to the pressure plate to move the pressure plate out of engagement with the drive plate.

These and other objects of the present invention may be more readily understood by reference to one or more of the following drawings.

### BRIEF DESCRIPTION OF THE DRAWINGS

FIGS. 1-5 illustrate the water pump with a clutch of the invention having a electromagnetic actuator;

FIGS. 6-9 illustrate a water pump with a clutch of the invention having an external solenoid as the actuator; and

FIGS. 10-12 illustrate a water pump with a clutch of the invention with an actuator as a vacuum piston.

### DETAILED DESCRIPTION OF THE DRAWINGS

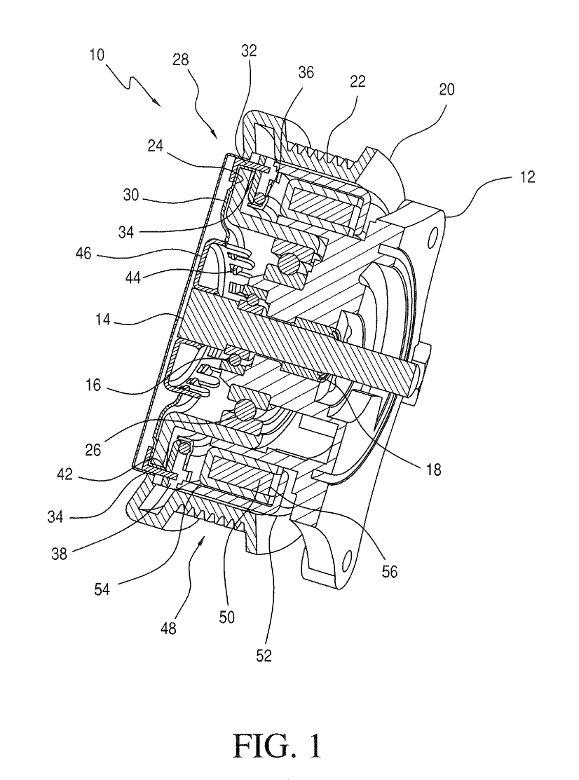

FIG. 1 illustrates a water pump with a clutch 10 having a pump housing 12, a pump shaft 14 that runs through the pump housing 12 and is connected to an impeller (not shown) and two pump shaft bearings 16 and 18. The pump housing 12 is fixed in a known manner inside the engine compartment of a vehicle.

A pulley 20 is rotatably fixed on the outside of the pump housing 12. The pulley 20 has a belt engagement surface 22 for engagement of a belt for the rotating pulley 20 and a clutch engagement surface 24 for engagement with a clutch 28 so as to connect the pulley 20 to the shaft 14. When the pulley 20 is disconnected from the shaft 14, the pulley 20 runs freely on a pulley bearing 26.

The clutch 28 has a drive plate 30 and a pressure plate 32, both of which are radially oriented and axially spaced inside the pump housing 12. The drive plate 30 is sandwiched between the pressure plate 32 and the clutch engagement surface 24. A Belleville spring 34 applies pressure against a bearing race 38 of a clutch isolation bearing 36 so as to ensure that the pressure plate 32 applies pressure to the drive plate 30. This pressure then ensures that there is frictional engagement between the drive plate 30, the pressure plate 32 and the clutch engagement surface 24. Slots 40 of a bearing race 38 are used to connect pressure plate axial teeth 42 with the bearing race 38. Drive plate radial teeth 44 connect the drive plate 30 with a spline plate 46. The spline plate 46 is fixed to the pump shaft 14.

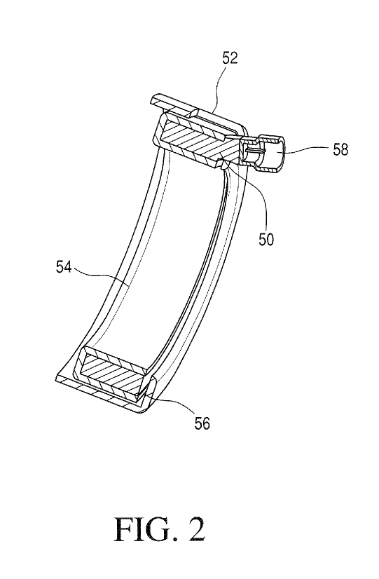

An actuator 48 has a coil 50 inside a core 54. A movable plunger 52 is moved by activating the coil 50. The distance of movement of the plunger 52 is shown by an air gap 56. A socket 58, see FIG. 2, is used to energize the coil 50 inside the core 54. The actuator 48 is secured in the pump housing 12 by press fitting the core 54 onto mating surfaces of the pump housing 12. On energizing the coil 50, the plunger 52 moves in an axial direction to close the air gap 56.

Under normal operating conditions, the coil 50 is disengaged. An air gap 56 is at its maximum and the Belleville spring 34 pushes the clutch isolation bearing (a thrust bearing) 36 axially to the right. Since the pressure plate 32 is fixed rigidly to the bearing race 38, the force of the Belleville spring 34 is transferred to the pressure plate 32. This ensures that the drive plate 30 is sandwiched between and frictionally held between the pressure plate 32 and the clutch engaging surface 24 of the pulley 20.

When the pulley 20 rotates, this rotational motion is transferred to the drive plate 30 which is splined to interact with the spline plate 46 using its drive plate radial teeth 44.

The spline plate 46 is rigidly attached to the pump shaft 14. Thus, the rotational motion of the pulley 20 is transferred to the pump shaft 14.

Upon energizing the coil 50, the plunger 52 moves axially to close the air gap 56. This results in the clutch isolation bearing 36 being pushed in a direction so as to compress the Belleville spring 34. This results in the pressure plate 32 lifting off of the surface of the drive plate 30 and freeing the drive plate 30. By freeing the drive plate 30, the frictional engagement between the drive plate 30 and the clutch engaging surface 24 is alleviated and the two surfaces can rotate freely, independent of one anther. Thus, the pulley 20 loses contact with the drive plate 30 and the rotational motion of the pulley 30 is no longer transferred to the drive plate 30. This, in turn, stops the rotational motion of the pump shaft 14.

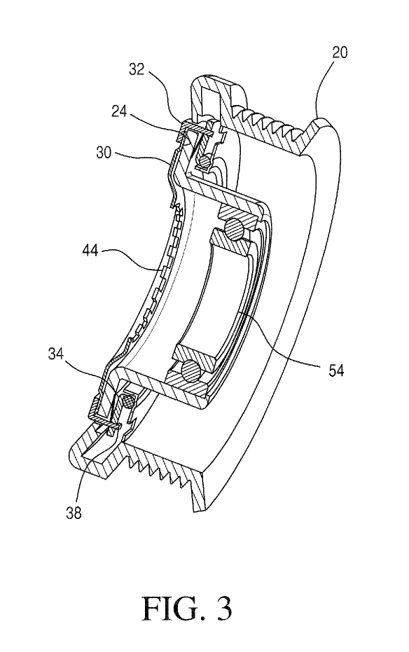

As illustrated in FIG. 3, the drive plate 30 is sandwiched between the pressure plate 32 and a clutch engaging surface 24 of the pulley 20. The drive plate radial teeth 44, see FIG. 1, ensure engagement between the drive plate 30 and a spline plate 46, see FIG. 1.

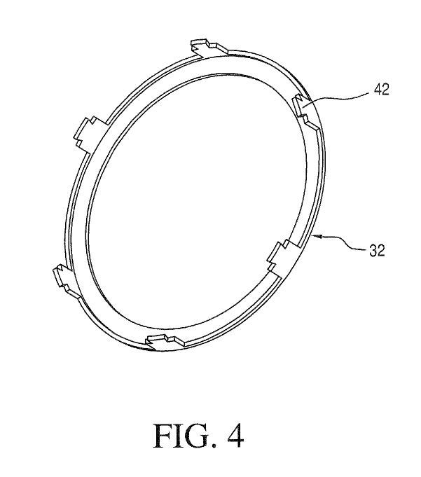

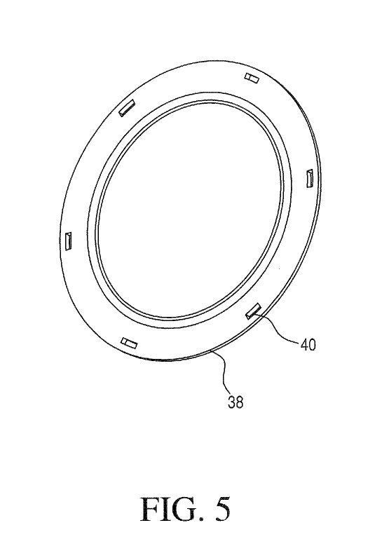

FIG. 4 illustrates the pressure plate 32 and the drive plate radial teeth 44.

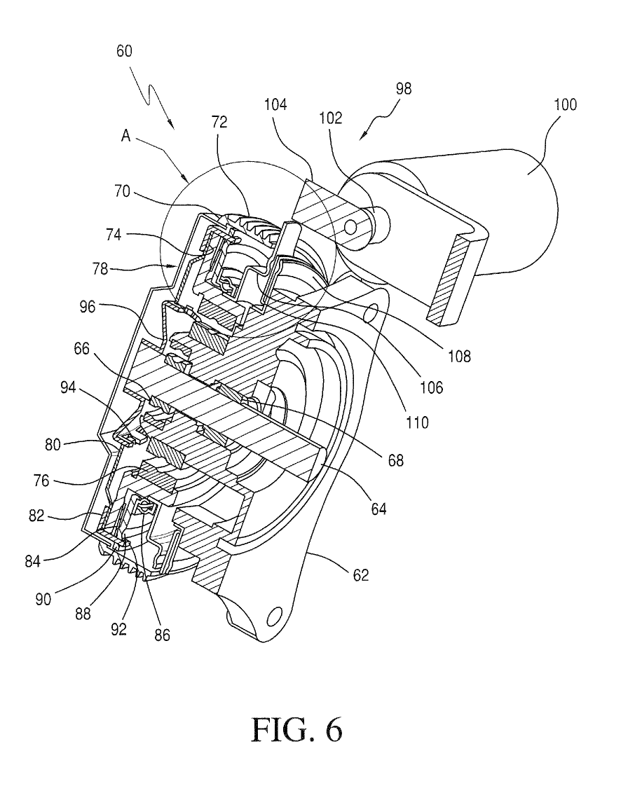

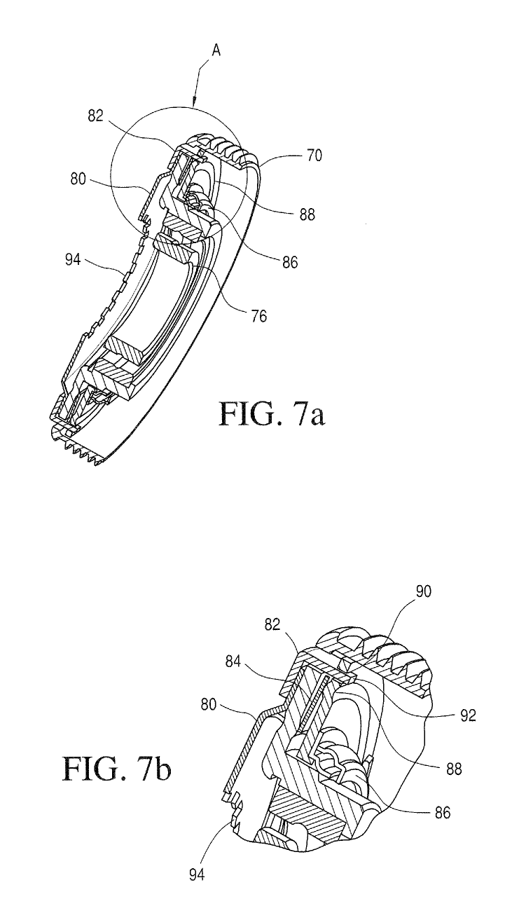

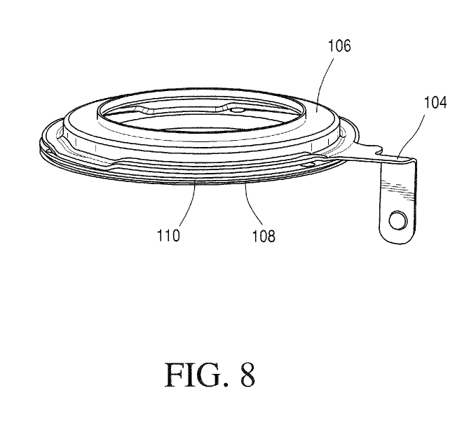

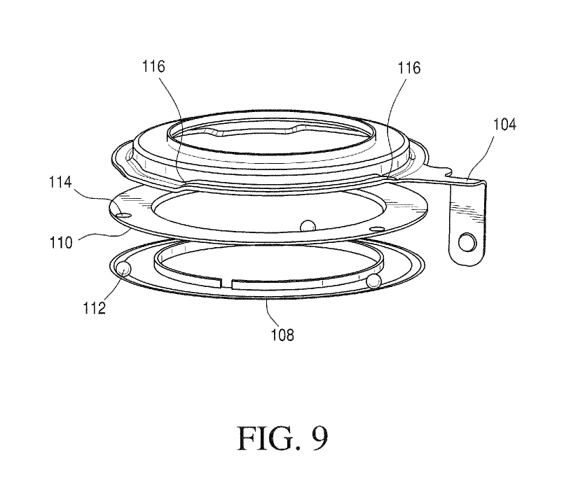

Turning to FIGS. 6-9, the figures illustrate a water pump with a clutch 60 having an actuator 98 with an external solenoid 100.

The water pump 60 has a pump housing 62 with a pump shaft 64 therein that rotates on a pump shaft bearing 66 and 68.

A pulley 70 has a belt engagement surface 72 and a clutch engagement surface 74.

The pulley 70 can rotate on a pulley bearing 76 when the clutch 78 is disengaged.

The clutch 78 has a drive plate 80 and a pressure plate 82, both of which are radially oriented and axially spaced about the pump shaft 64 in the housing 62. A Belleville spring 84 presses against a back plate 88 of a clutch isolation bearing 86. Slots 90 in the back plate 88 engage pressure plate axial teeth 92 so as to fix a pressure plate 82 to the back plate 88. Drive plate radial teeth 94 interact with a spline plate 96 which is fixed to the pump shaft 64.

An actuator 98 has a solenoid 100 with a solenoid shaft 102. The solenoid shaft 102 interacts with a ramp plate arm 104. The ramp plate arm 104 is fixed to a ramp plate 106. The ramp plate 106 is radially oriented in the pump housing 62. A base plate 108 has rollers 112 which are held in place by a roller carrier plate 110. The roller carrier plate 110 has holes 114. The activation of the solenoid 100 causes the solenoid shaft 102 to push against the ramp plate arm 104 which in turn rotates the ramp plate 106. This rotational motion of the ramp plate 106 causes the ramps 116 to roll over the rollers 112 and translates the rotational motion of the ramp plate 106 into axial motion. This axial motion is transferred by the clutch isolation bearing 86 to the pressure plate 82 and causes the pressure plate 82 to move axially away from the drive plate 80. This movement of the pressure plate 82 away from the drive plate 80 allows the drive plate 80 to disengage from the clutch engagement surface 74 of the pulley 70 and thereby disengage the pulley 70 from the shaft 64.

The Belleville spring 84 provides a preload to the clutch isolation bearing 86 so as to maintain the pressure plate 82 pressing against the drive plate 80 and thereby provide frictional engagement between the pressure plate 82, the drive plate 80, and the clutch engagement surface 74.

The rollers 112 are equally spaced on the roller carrier plate 110. The base plate 108 is keyed to the pump housing 62 so as to fix it in the housing 62 and allow the ramps 116 to ride over the rollers 112 during rotational motion provided by the solenoid 110. As will be appreciated, the axial motion provided by the ramps 116 are transferred to the clutch isolation bearing 86 so as to force axial movement of the pressure plate 82 and disengage the pressure plate 82 from the drive plate 80.

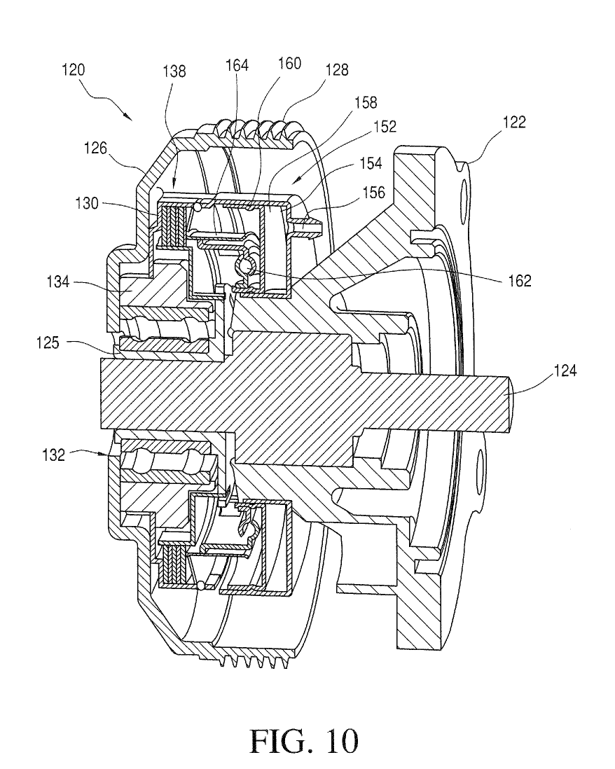

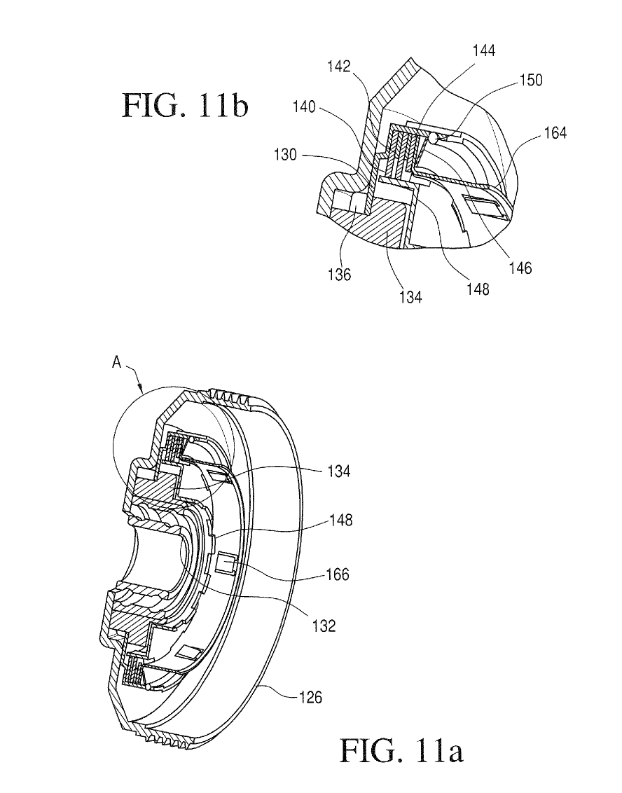

FIGS. 10-12 illustrate a water pump with a clutch 120 having a vacuum actuator 152.

The water pump 120 has a pump housing 122 with a pump shaft 124 therein. A pump shaft 124 is illustrated without bearings for purposes of simplicity. A shaft sleeve 125 with slots is used for engagement with drive plates 140 and 142.

A pulley 126 has a belt engagement surface 128 and a clutch engagement surface 130. The clutch engagement surface 130 is connected to a hub 134 by keys 136. The hub 134 is fixed to the pulley 126. A pulley bearing 132 allows the pulley 126 to freely rotate when the clutch 138 is disengaged.

A clutch 138 has an inner drive plate 140 and an outer drive plate 142. A pressure plate 144 presses drive plates 140 and 142 against the clutch engagement surface 130. A Belleville spring 146 presses against a lock tube 164 which in turn is pressed against a pressure plate 144. A spline drive plate 148 is fixed to drive plates 140 and 142 and connected to a shaft sleeve 125. A retainer ring 150 is used to keep the Belleville spring 146 in engagement with the lock tube 164.

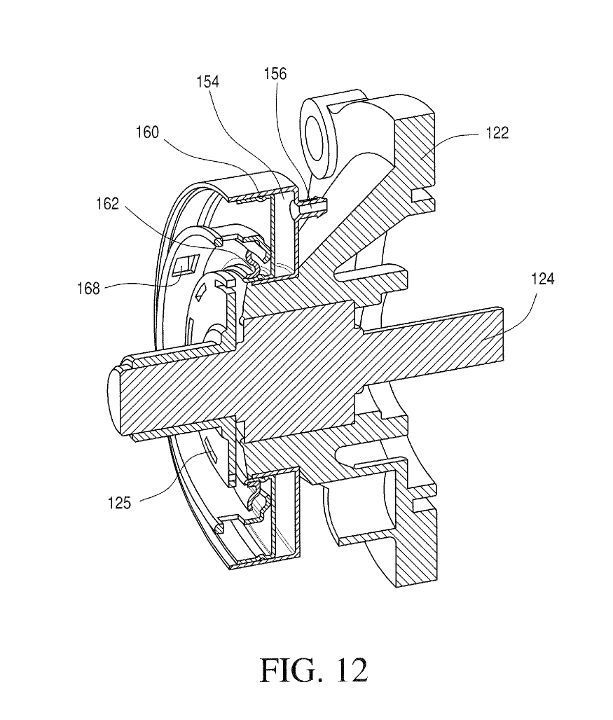

The actuator 152 is a vacuum actuator having a vacuum chamber 154 which is connected to a vacuum tube 156. A piston member is moved axially to the right upon creating a vacuum inside the vacuum chamber 154. O-rings 160 maintain a good seal between the sliding surfaces as illustrated in FIG. 12. A clutch isolation bearing 162 is connected to a piston 158 and moves with the piston 158. The isolation bearing 162 is also connected to a lock tube 164 to move the lock tube 164 axially to the right as shown in FIG. 10.

The lock tube 164 has tabs 166 to interact with slots 168 of the clutch isolation bearing 162.

A vacuum is available in a conventional automotive engine from the engine manifold. Vacuum valves can be provided to turn on and turn off the vacuum and are connected through a vacuum tube 156 to a vacuum chamber 154.

In operation, when the vacuum is applied to the vacuum chamber 154 through the vacuum tube 156, the piston member 158 moves axially to the right. The piston member 158 is fixed to the clutch isolation bearing 162 so as to cause the clutch isolation bearing 162 to also move axially to the right. This axial movement is then translated by the slots 168 to the tabs 166 and the lock tube 164. Axial movement to the right of the lock tube 164 removes pressure applied by the pressure plate 144 against the drive plates 140 and 142. This in turn disengages the frictional engagement of the drive plates 140 and 142 with the clutch engagement surface 130. This disengages the pulley 126 from the shaft 124.

### Reference Characters

10 water pump with clutch

12 pump housing

14 pump shaft

16 pump shaft bearing

18 pump shaft bearing

20 pulley

22 belt engagement surface

24 clutch engagement surface

26 pulley bearing

28 clutch

30 drive plate

32 pressure plate

34 Belleville spring

36 clutch isolation bearing (thrust bearing)

38 bearing race

40 slots

42 pressure plate axial teeth

44 drive plate radial teeth

46 spline plate

48 actuator

50 coil

52 plunger

54 core

56 air gap

58 socket

60 water pump with clutch

62 pump housing

64 pump shaft

66 pump shaft bearing

68 pump shaft bearing

70 pulley

72 belt engagement surface

74 clutch engagement surface

76 pulley bearing

78 clutch

80 drive plate

82 pressure plate

84 Belleville spring

86 clutch isolation bearing

88 back plate

90 slots

92 pressure plate axial teeth

94 drive plate radial teeth

96 spline plate

98 actuator

100 solenoid

102 solenoid shaft

104 ramp plate arm

106 ramp plate

108 base plate

110 roller carrier plate

112 rollers

114 holes

116 ramps

120 water pump with clutch

122 pump housing

124 pump shaft (bearings not shown)

125 shaft sleeve with slots

126 pulley

128 belt engagement surface

130 clutch engagement surface

132 pulley bearing

134 hub

136 key

138 clutch

140 inner drive plate

142 outer drive plate

144 pressure plate

146 Belleville spring

148 spline drive plate

150 retainer ring

152 actuator

154 vacuum chamber

156 vacuum tube

158 piston member

160 O-ring

162 clutch isolation bearing

164 lock tube

166 tabs

168 slots

1. A water pump with a clutch for an internal combustion engine comprising:
a pump housing having a pump shaft therein;
a pulley rotatably mounted on the pump housing, the pulley having a radial clutch engagement surface;
a clutch having a spring, a drive plate, and a movable pressure plate, the drive plate radially mounted about the pump shaft and positioned axially between the clutch engagement surface and the pressure plate, the pressure plate radially mounted about the pump shaft and axially adjacent the drive plate, and the spring radially mounted about the pump shaft and urging the pressure plate, the drive plate, and the clutch engagement surface into frictional engagement with each other; and
an actuator for moving the pressure plate out of engagement with the drive plate and disconnecting the pulley from the pump shaft.

2. The pump of claim 1, wherein
the actuator is an electromagnetic actuator having a coil and a movable plunger, the plunger is engagable with the pressure plate when the coil is energized so as to move the pressure plate out of engagement with the drive plate.

3. The pump of claim 1, wherein
the actuator is a solenoid mounted externally to the pump housing, a movable ramped plate is radially mounted about the pump shaft in the pump housing, the ramped plate is axially spaced apart from and engagable with the pressure plate, a base plate is radially mounted about the pump shaft in the pump housing and spaced axially adjacent the ramped plate and roller elements are fixed to the base plate and in rolling engagement with the ramped plate, the solenoid having a solenoid shaft that engages and rotates the ramped plate when the solenoid is energized so that the roller elements axially move the ramped plate to engage and move the pressure plate out of engagement with the drive plate.

4. The pump of claim 1, wherein
the actuator is a vacuum piston mounted in the pump housing with a piston member connected to the pressure plate to move the pressure plate out of engagement with the drive plate.
